(19) United States
(12) Patent Application Publication
(10) Pub. No.: US 2026/0067807 A1
(43) Pub. Date: Mar. 5, 2026

(54) ENHANCED COORDINATED RESTRICTED TWT OPERATION

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US); Yue Qi, Plano, TX (US); Bilal Sadiq, Plano, TX (US)

(21) Appl. No.: 19/313,742

(22) Filed: Aug. 28, 2025

Related U.S. Application Data
(60) Provisional application No. 63/691,158, filed on Sep. 5, 2024.
(60) Provisional application No. 63/692,521, filed on Sep. 9, 2024.
(60) Provisional application No. 63/698,442, filed on Sep. 24, 2024.

(51) Int. Cl. H04W 52/02; H04W 72/0446; H04W 88/08

(52) U.S. Cl. CPC H04W 52/0219; H04W 72/0446; H04W 88/08

(57) ABSTRACT

A first access point (AP) includes a processor. The processor is configured to cause the first AP to perform a negotiation for Multi-AP (MAP) target wake time (TWT) coordination. The first AP also includes a transceiver operably coupled to the processor. The transceiver is configured to, during the negotiation for MAP TWT coordination, (i) transmit a MAP coordination request frame, and (ii) receive, from a second AP, a MAP coordination response frame. The second AP is an overlapping basic service set (OBSS) AP for the first AP.

### CROSS-REFERENCE TO RELATED APPLICATION(S) AND CLAIM OF PRIORITY

This application claims priority under 35 U.S. C. § 119(e) to U.S. Provisional Patent Application Ser. No. 63/691,158 filed on Sep. 5, 2024, U.S. Provisional Patent Application Ser. No. 63/692,521 filed on Sep. 9, 2024, and U.S. Provisional Patent Application Ser. No. 63/698,442 filed on Sep. 24, 2024. The above-identified provisional patent applications are hereby incorporated by reference in their entirety.

### TECHNICAL FIELD

This disclosure relates generally to wireless networks. More specifically, this disclosure relates to enhanced coordinated restricted target wake time (TWT) operation.

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for enhanced coordinated restricted TWT operation.

In one embodiment, a first access point (AP) is provided. The first access point includes a processor. The processor is configured to cause the first AP to perform a negotiation for Multi-AP (MAP) target wake time (TWT) coordination. The first AP also includes a transceiver operably coupled to the processor. The transceiver is configured to, during the negotiation for MAP TWT coordination, (i) transmit a MAP coordination request frame, and (ii) receive, from a second AP, a MAP coordination response frame. The second AP is an overlapping basic service set (OBSS) AP for the first AP.

In another embodiment, a second AP is provided. The second AP includes a processor, and a transceiver operatively coupled to the processor. The transceiver is configured to, during a negation for MAP TWT coordination, (i) receive, from a first AP, a MAP coordination request frame, and (ii) transmit, to the first AP, a MAP coordination response frame. The first AP is an overlapping basic service set (OBSS) AP for the second AP.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example Type-I architecture for coordinated TWT negotiation according to embodiments of the present disclosure;

FIG. 4 illustrates an example Type-II architecture for coordinated TWT negotiation according to embodiments of the present disclosure;

FIG. 5 illustrates an example of phases of MAP TWT coordination according to embodiments of the present disclosure;

FIG. 6 illustrates an example format of a MAP coordination request frame carrying coordinated TWT information according to embodiments of the present disclosure;

FIG. 7 illustrates an example format of a TWT coordination element according to embodiments of the present disclosure;

FIG. 8 illustrates an example negotiation for MAP TWT coordination according to embodiments of the present disclosure;

FIG. 9 illustrates an example of C-R-TWT phases according to embodiments of the present disclosure;

FIG. 10 illustrates an example of frame exchanges for C-R-TWT according to embodiments of the present disclosure;

FIG. 11 illustrates an example of propagation of changes in R-TWT according to embodiments of the present disclosure;

FIG. 12 illustrates an example AID grouping for MAP coordination according to embodiments of the present disclosure;

FIG. 13 illustrates an example use of different sets of AIDs for non-AP STAs and APs according to embodiments of the present disclosure;

FIG. 14 illustrates an example AID assignment during a MAP negotiation phase according to embodiments of the present disclosure;

FIG. 15 illustrates an example AID assignment in separate management frame exchanges according to embodiments of the present disclosure; and

FIG. 16 illustrates an example method for enhanced coordinated restricted TWT operation according to embodiments of the present disclosure.

### DETAILED DESCRIPTION

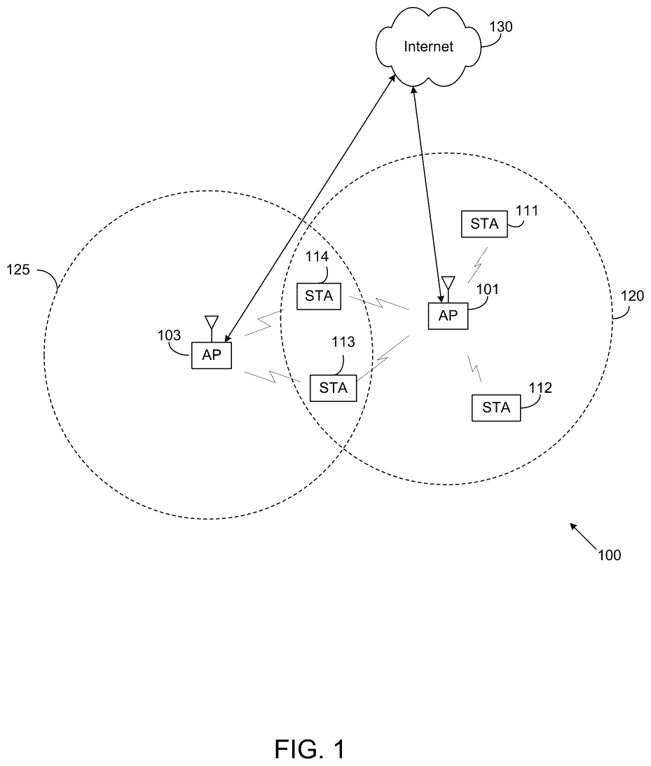

FIGS. 1 through 16, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

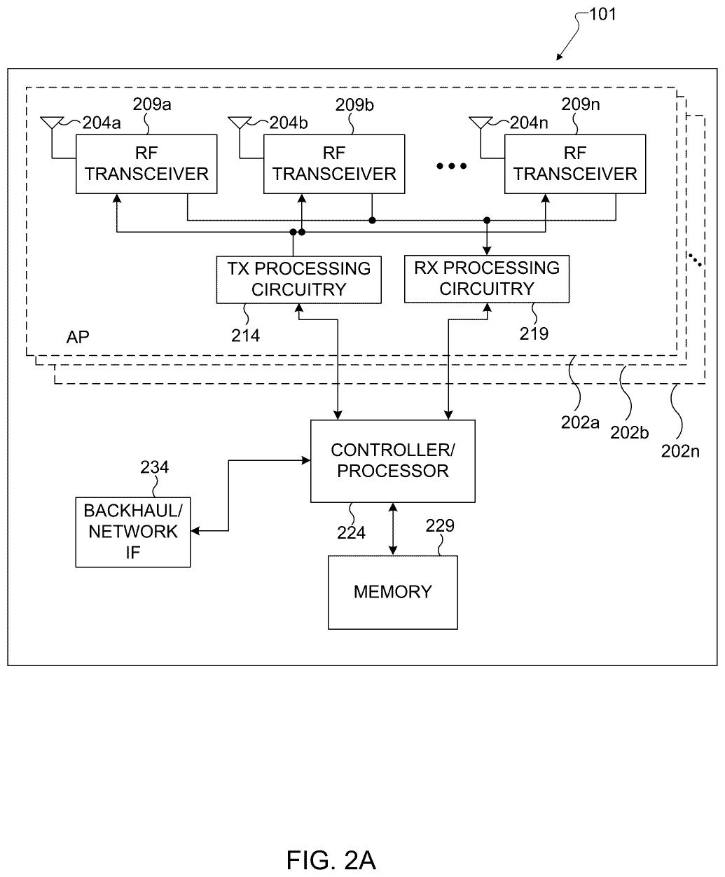

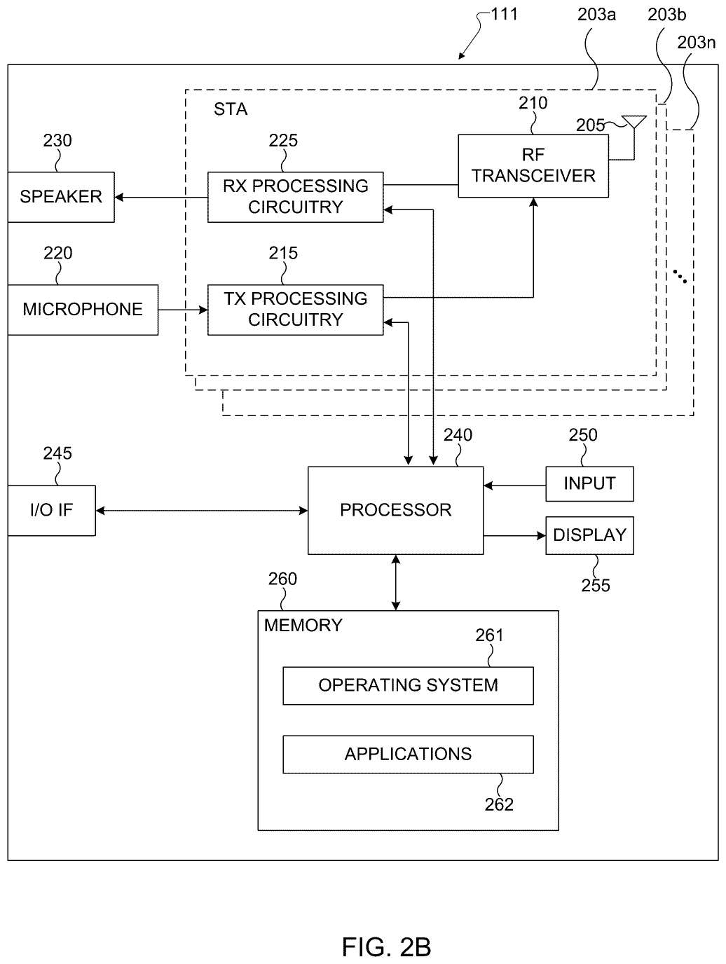

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Existing wireless networks may utilize the target wake time (TWT) feature for power management. TWT allows an AP to manage activity in the basic service set (BSS) in order to minimize contention between STAs and to reduce the required amount of time that a STA utilizing a power management mode needs to be awake. This is achieved by allocating STAs to operate at non-overlapping times and/or frequencies, and concentrating the frame exchange sequences in predefined service periods. With TWT operation, it suffices for a STA to only wake up at pre-scheduled times negotiated with another STA or AP in the network. A STA does not need to be aware of the values of TWT parameters of the TWT agreements of other STAs in the BSS of the STA or of TWT agreements of STAs in other BSSs. A STA does not need to be aware that a TWT service period (SP) is used to exchange frames with other STAs. Frames transmitted during a TWT SP are carried in any physical protocol data unit (PPDU) format supported by the pair of STAs that have established the TWT agreement corresponding to that TWT SP, including high-efficiency (HE) mutli-user (MU) PPDU, HE trigger-based (TB) PPDU, etc.

In existing wireless networks, two types of TWT operation are available—individual TWT operation and broadcast TWT operation. Individual TWT agreements can be established between two STAs or between a STA and an AP. The negotiation that takes place for an individual TWT agreement between two STAs is on an individual basis. The AP can have TWT agreements with multiple STAs. Any changes in the TWT agreement between the AP and one STA does not affect the TWT agreement between the AP and the other STA.

Broadcast TWT operates in a membership-based approach. With broadcast TWT operation, an AP can set up a shared TWT session for a group of STAs. The AP is typically the controller of the broadcast TWT schedule. The non-AP STAs in the BSS can request membership in the schedule or the AP can send unsolicited responses to the STA to make the STA a member of the broadcast TWT schedule the AP maintains in the BSS. The AP can advertise/announce and maintain multiple broadcast TWT schedules in the network. When a change is made to any of the schedules in the network, it affects all the STAs that are members of that particular schedule.

As noted above, existing wireless networks also support MLO. With MLO, it is possible for a non-AP MLD to discover, authenticate, associate, and set up multiple links with an AP MLD. Channel access and frame exchange is possible on each link between the AP MLD and non-AP MLD. For individual TWT agreements between two MLDs, a STA affiliated with an MLD, which is a TWT requesting STA, may indicate the link(s) that are requested for setting up TWT agreement(s) in the link ID bitmap subfield, if present, of a TWT element in the TWT request. If only one link is indicated in the link ID bitmap subfield of the TWT element, then a single TWT agreement is requested for the STA affiliated with the same MLD, which is operating on the indicated link. The target wake time field of the TWT element references the time synchronization function (TSF) time of the link indicated by the TWT element. A TWT responding STA affiliated with a peer MLD that receives a TWT request that contains a link ID bitmap subfield in a TWT element responds with a TWT response that indicates the link(s) in the link ID bitmap field of a TWT element. The link(s), if present, in the TWT element carried in the TWT response, are the same as the link(s) indicated in the TWT element of the soliciting TWT request.

Existing wireless networks may also utilize restricted TWT (rTWT) operation to provide better support for latency sensitive applications. Restricted TWT offers a protected service period for its member STAs by sending quiet elements to other STAs in the BSS which are not members of the rTWT schedule, where the quiet interval corresponding to the quiet element overlaps with the initial portion of the restricted TWT SP. Therefore, rTWT gives more channel access opportunity for the rTWT member scheduled STAs, which helps latency-sensitive traffic flow.

Interference from one BSS often causes performance issues for STAs and APs in nearby BSSs. This naturally results in overall throughput degradation in the network. The Overlapping BSS (OBSS) interference can also increase the overall latency since it takes more time for accessing the channel due to the interference occupying the channel. If a STA in a BSS has latency-sensitive traffic, this delay in channel access can seriously hamper the STA's latency-sensitive applications. TWT-based Multi-AP (MAP) coordination is desirable for next-generation WLAN networks.

In some embodiments, a first AP can coordinate with a second AP in the vicinity of the first AP in order to coordinate with the first AP's individual TWT agreement, broadcast TWT schedule, or restricted TWT (R-TWT) schedule. The coordination mechanism can take different formats based on the architecture of the coordinated TWT (C-TWT) negotiation.

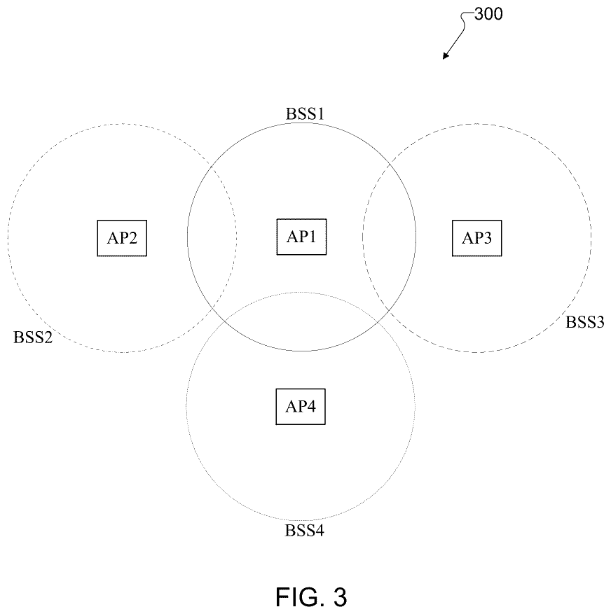

In Type-I architecture of C-TWT negotiation, the APs (for example R-TWT scheduling APs) participating in the TWT MAP coordination can directly exchange frames within themselves to negotiate the MAP TWT coordination. A Type-I architecture for coordinated TWT negotiation is shown in FIG. 3.

FIG. 3 illustrates an example Type-I architecture for coordinated TWT negotiation 300 according to embodiments of the present disclosure. The embodiment of a Type-I architecture for coordinated TWT negotiation of FIG. 3 is for illustration only. Different embodiments of a Type-I architecture for coordinated TWT negotiation could be used without departing from the scope of this disclosure.

In the example of FIG. 3, AP1 is a member of BSS1, AP2 is a member of BSS2, AP3 is a member of BSS3, and AP 4 is a member of BSS4. BSS2, BSS3, and BSS4 are each an OBSS of BSS 1. However, none of BSS2, BSS3, or BSS4 overlap each other in FIG. 3.

Although FIG. 3 illustrates one example Type-I architecture for coordinated TWT negotiation 300, various changes may be made to FIG. 3. For example, various changes to the number of APs could be made, different BSSs could overlap, etc. according to particular needs.

TWT based MAP coordination is a useful feature for next generation WLANs. A part of MAP coordination involves explicit negotiation between the participating APs. However, currently there are no frameworks for MAP for protecting an R-TWT schedule across multiple BSSs. Various embodiments of the present disclosure provide mechanisms and procedures for TWT based MAP coordination.

As noted above, TWT based MAP coordination is a useful feature for next generation WLANs. However, how the different modes of coordinated-restricted-TWT (C-R-TWT) would be advertised and negotiated for is not clear or defined. Various embodiments of the present disclosure provide mechanisms and procedures for intra and inter BSS operation for establishing C-R-TWT.

In Type-II architecture of C-TWT negotiation, the APs'(for example R-TWT scheduling APs) R-TWT negotiations are controlled by an R-TWT central controller. Any kind of R-TWT MAP negotiations are performed through the central controller. A Type-II architecture for coordinated TWT negotiation is shown in

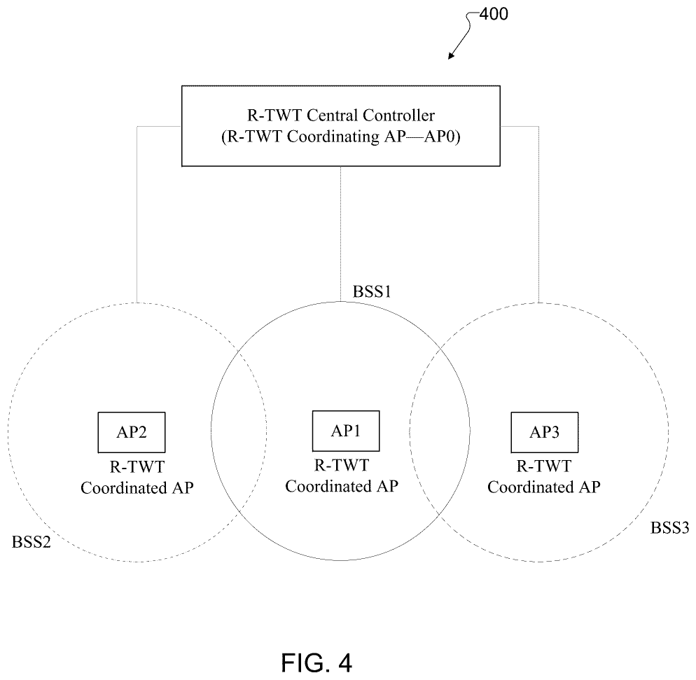

FIG. 4 illustrates an example Type-II architecture for coordinated TWT negotiation 400 according to embodiments of the present disclosure. The embodiment of a Type-II architecture for coordinated TWT negotiation of FIG. 4 is for illustration only. Different embodiments of a Type-II architecture for coordinated TWT negotiation could be used without departing from the scope of this disclosure.

In the example of FIG. 4, AP1 is a member of BSS1, AP2 is a member of BSS2, and AP3 is a member of BSS3. BSS2, and BSS3 are each an OBSS of BSS 1. However, BSS2 and BSS3 do not overlap in FIG. 4. AP1, AP2, and AP3 utilize an R-TWT central controller (AP0) to perform R-TWT MAP negotiations.

Although FIG. 4 illustrates one example Type-II architecture for coordinated TWT negotiation 400, various changes may be made to FIG. 4. For example, various changes to the number of APs could be made, different BSSs could overlap, etc. according to particular needs.

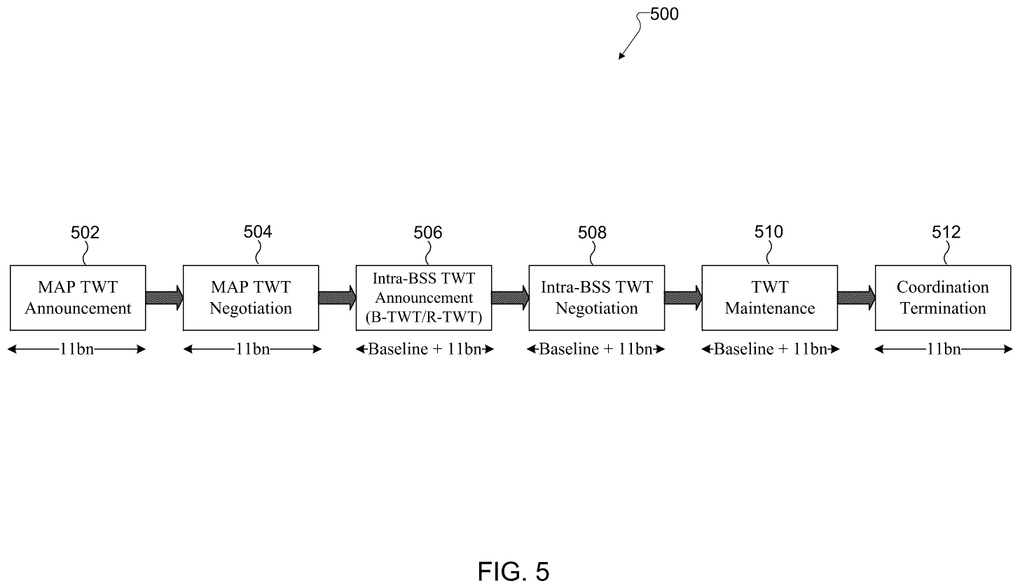

FIG. 5 illustrates an example of phases of MAP TWT coordination 500 according to embodiments of the present disclosure. The embodiment of phases of MAP TWT coordination of FIG. 5 is for illustration only. Different embodiments of phases of MAP TWT could be used without departing from the scope of this disclosure.

In the example of FIG. 5, the MAP TWT coordination includes the following phases:
MAP TWT Announcement (502)
MAP TWT Negotiation (504)
Intra-BSS TWT Announcement (506)
Intra-BSS TWT Negotiation (508)
Maintenance of a TWT schedule/agreement (510)
Termination of TWT coordination (512)

Although FIG. 5 illustrates one example of phases of MAP TWT coordination 500, various changes may be made to FIG. 5. For example, various changes to the number of phases, the types of phases, etc. could be made according to particular needs.

In some embodiments, the same framework shown in FIG. 5 also be applied for other MAP coordination such as C-TDMA, C-SR etc.

In existing wireless networks, there is no mechanism through which a first AP can identify or indicate a second AP. Such a mechanism would be beneficial for MAP coordination purposes.

Various embodiments of the present disclosure provide frameworks for AP identification procedures for MAP coordination.

As noted above, various embodiments of the present disclosure provide mechanisms and procedures for TWT based MAP coordination.

In some embodiments, based on Type-I architecture for coordinated TWT negotiation, a first AP intending to participate in a MAP TWT coordination can send a MAP coordination request frame to a second AP (which can be an OBSS AP for the first AP) in order to request MAP TWT coordination.

In some embodiments, for the scenario where a first AP intends to initiate a MAP coordination with a second AP, and goes into negotiation phase, the first AP can send a MAP coordination request frame to the second AP.

In some embodiments, for the scenario where a first AP intends to initiate a MAP coordination with a second AP, where the coordination is for TWT based coordination, and the first AP goes into negotiation phase with the second AP, the first AP can send a MAP coordination request frame to the second AP, where the frame can include TWT coordination related information.

In some embodiments, a first AP that receives a MAP coordination request frame from a second AP can send a MAP coordination response frame to the second AP indicating the first APs preferred parameters for the MAP coordination.

In some embodiments, a MAP Coordination request frame may include information for different types of MAP coordination. For example, the frame may include a presence bitmap where each bit corresponding to the presence bitmap may indicate whether information corresponding to a particular coordination method is present in the frame.

In some embodiments, a MAP coordination request frame may have a format similar as shown in

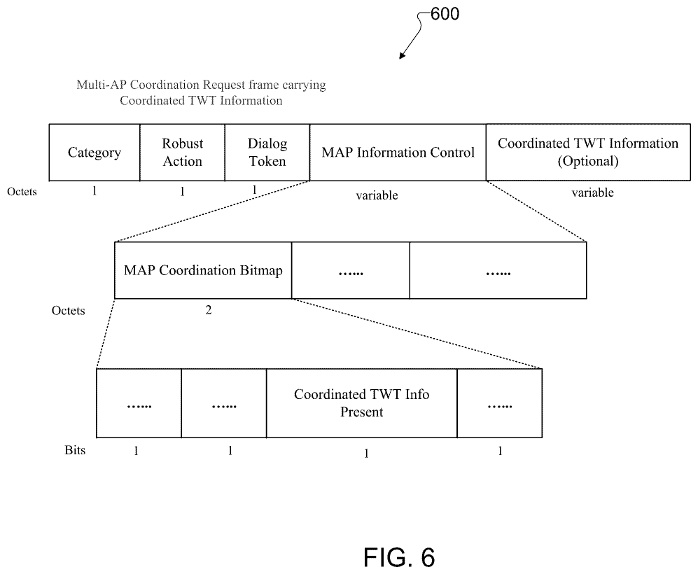

FIG. 6 illustrates an example format of a MAP coordination request frame carrying coordinated TWT information 600 according to embodiments of the present disclosure. The embodiment of a MAP coordination request frame of FIG. 6 is for illustration only. Different embodiments of a MAP coordination request frame carrying coordinated TWT information could be used without departing from the scope of this disclosure.

In the example of FIG. 6, the MAP coordination request frame includes a MAP information control field. In some embodiments, the MAP information control field may include a MAP coordination bitmap. This bitmap may be referred to as a coordinate TWT info present subfield. In some embodiments, the coordinate TWT info present subfield may indicate whether a coordinated TWT information field is present in the request frame. If the subfield is set to 1, this may indicate that the coordinated TWT information field is present in the frame. Otherwise, the coordinated TWT information field is not present.

In some embodiments, the coordinated TWT information field may contain one or more TWT coordination elements. A TWT coordination element may contain information for one or more of TWT schedules that the AP sending the element wants to coordinate with another AP.

Although FIG. 6 illustrates an example format a MAP coordination request frame carrying coordinated TWT information 600, various changes may be made to FIG. 6. For example, various changes to fields could be made, etc. according to particular needs.

In some embodiments, a TWT coordination element may have a format similar as shown in

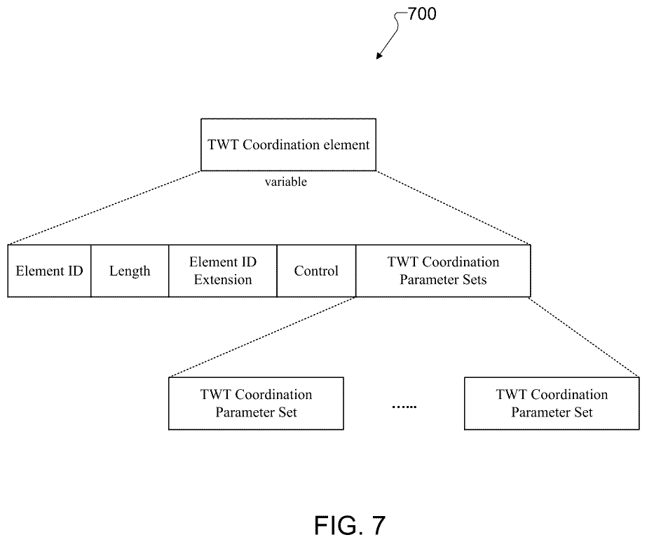

FIG. 7 illustrates an example format of a TWT coordination element 700 according to embodiments of the present disclosure. The embodiment of a TWT coordination element of FIG. 7 is for illustration only. Different embodiments of a TWT coordination element could be used without departing from the scope of this disclosure.

In the example of FIG. 7, the TWT coordination element includes one or more TWT coordination parameter sets. Each TWT coordination parameter set may correspond to one TWT schedule that the AP sending the element wants to coordinate with another AP.

Although FIG. 7 illustrates an example format of a TWT coordination element 700, various changes may be made to FIG. 7. For example, various changes to fields could be made, etc. according to particular needs.

In some embodiments, a MAP coordination response frame format can be similar to that of a MAP coordination request frame. For example, a MAP coordination response frame may have the same format as the MAP coordination request frame carrying coordinated TWT information 600 as shown in FIG. 6

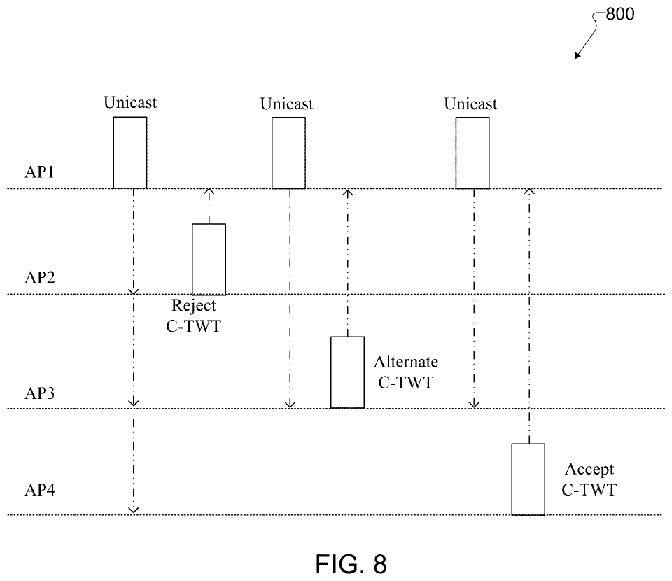

A frame exchange for TWT coordination negotiation is shown in FIG. 8.

FIG. 8 illustrates an example negotiation for MAP TWT coordination 800 according to embodiments of the present disclosure. The embodiment of a negotiation for MAP TWT coordination of FIG. 8 is for illustration only. Different embodiments of a negotiation for MAP TWT coordination could be used without departing from the scope of this disclosure.

In the example of FIG. 8, the frames transmitted by AP1 are MAP coordination request frames, and the frames transmitted by AP2-AP4 are MAP coordination response frames.

In FIG. 8, AP1 transmits a MAP coordination request to AP2-AP4. AP2 rejects the request and AP3 suggests an alternative MAP coordination. AP4 accepts the MAP coordination request.

Although FIG. 8 illustrates an example negotiation for MAP TWT coordination 800, various changes may be made to FIG. 8. For example, various changes to the number of APs could be made, etc. according to particular needs.

As noted above, various embodiments of the present disclosure provide mechanisms and procedures for intra and inter BSS operation for establishing C-R-TWT.

In some embodiments, for an end-to-end C-R-TWT operation, some phases can be part of a generalized MAP framework, while others can be R-TWT-specific procedures.

In some embodiments for the generalized segments (i.e., MAP Discovery and parameter negotiation), all the MAP coordination techniques can use the same vehicle/information container.

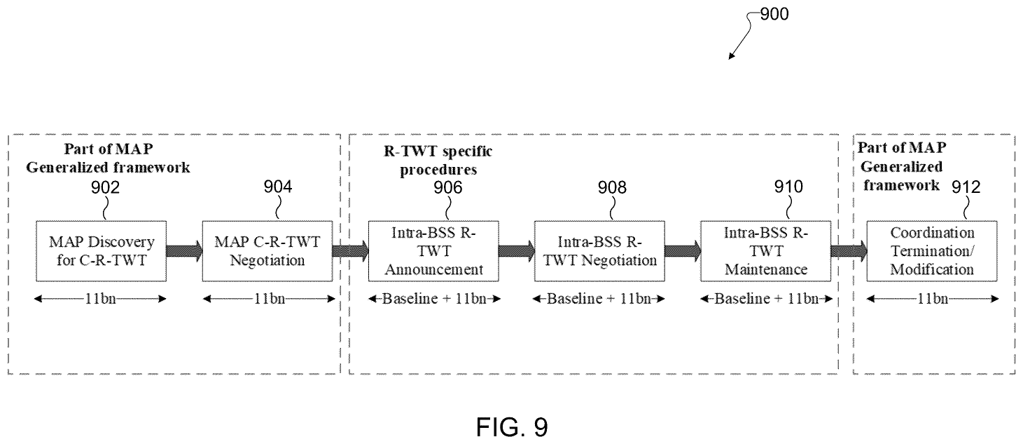

In some embodiments, an end-to-end C-R-TWT operation may include the phases shown in FIG. 9.

FIG. 9 illustrates an example of C-R-TWT phases 900 according to embodiments of the present disclosure. The embodiment of C-R-TWT phases of FIG. 9 is for illustration only. Different embodiments of phases of C-R-TWT phases could be used without departing from the scope of this disclosure.

In the example of FIG. 9, end-to-end C-R-TWT operation includes the following phases:

Part of MAP generalized framework:
MAP discovery for C-R-TWT (902)
MAP C-R-TWT negotiation (904)
Termination/modification of C-R-TWT coordination (912)
   Part of R-TWT specific procedures:
Intra-BSS R-TWT announcement (906)
Intra-BSS R-TWT negotiation (908)
Maintenance of an R-TWT schedule/agreement (910)

Although FIG. 9 illustrates one example of C-R-TWT phases 900, various changes may be made to FIG. 9. For example, various changes to the number of phases, the types of phases, etc. could be made according to particular needs.

In some embodiments, during a discovery phase (e.g., 902 of FIG. 9), the C-R-TWT initiating AP advertises/announces its intent for R-TWT-based MAP coordination to other APs. In some embodiments, basic C-R-TWT-related capabilities and other coordination information can be included in the advertisement. Schedule information can optionally be shared during the discovery phase.

In some embodiments an AP that receives a C-R-TWT announcement from the initiating AP and is willing to participate in the C-R-TWT coordination may respond to the announcement. In embodiments such as these, the responder AP may include its C-R-TWT capability information in its response. In some embodiments, the capability information may include support for different modes of C-R-TWT.

In some embodiments, during a negotiation phase (e.g., 904 of FIG. 9), a C-R-TWT initiating AP may perform explicit parameter negotiation with an AP that responded to a C-R-TWT advertisement of the initiating AP. This may be referred to as a 1-to-1 request-response based approach. In some embodiments, the responding AP may also suggest an alternative parameter set the responding AP can support. As described herein, the AP responding to the C-R-TWT advertisement may be referred to as a coordinated AP.

In some embodiments, the negotiation parameters may include one or more of the following:
Schedule timing information: TWT, wake duration, and interval mantissa and exponent
Schedule persistence
Mode of C-R-TWT
Schedule identifier (the schedule identifier can be different than a broadcast-TWT [B-TWT] ID used for intra-BSS operation)

In some embodiments, negotiation parameters may be exchanged by repurposing an existing TWT element. In some embodiments, negotiation parameters may be exchanged via a dedicated container.

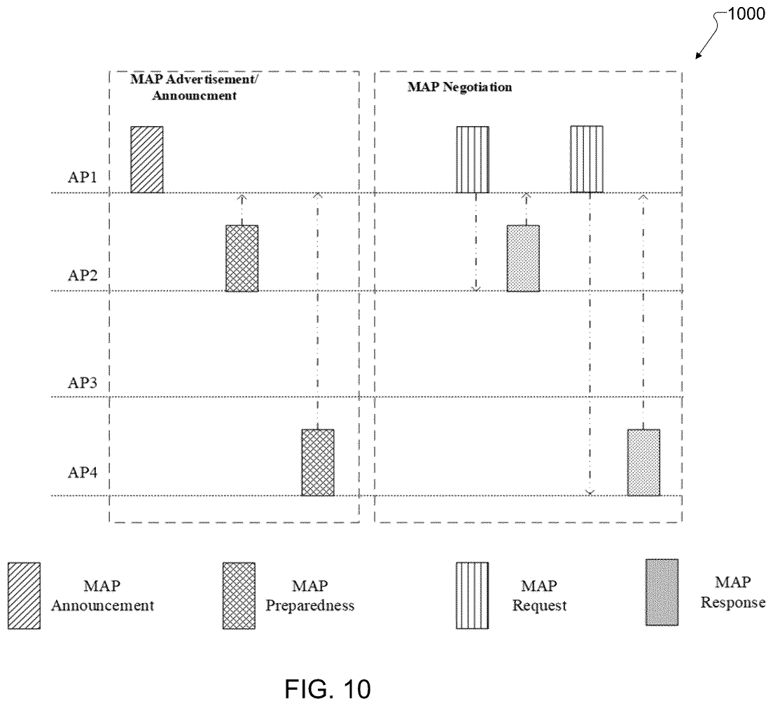

An example frame exchange for C-R-TWT discovery and negotiation is shown in FIG. 10.

FIG. 10 illustrates an example of frame exchanges for C-R-TWT 1000 according to embodiments of the present disclosure. The embodiment of frame exchanges for C-R-TWT of FIG. 8 is for illustration only. Different embodiments of frame exchanges for C-R-TWT could be used without departing from the scope of this disclosure.

In the example of FIG. 10, during the MAP advertisement/announcement, the frames transmitted by AP1 are MAP announcement frames, and the frames transmitted by AP2-AP4 are MAP preparedness frames. In some embodiments, the MAP announcement and MAP preparedness frames can include an indication of R-TWT-based coordination and the corresponding capability information.

During the MAP advertisement/announcement, AP1 transmits a MAP announcement frame. AP2 and AP4 respond to the MAP announcement frame by each transmitting a map preparedness frame to AP 1.

In the example of FIG. 10, during the MAP negotiation, the frames transmitted by AP1 are MAP request frames, and the frames transmitted by AP2-AP4 are MAP response frames. In some embodiments, the MAP request and response frames may include exact C-R-TWT negotiation parameters.

During the MAP negotiation, AP1 transmits a MAP request frame to AP2. In response to receiving the MAP request frame, AP2 transmits a MAP response frame to AP1. Similarly, AP1 transmits a MAP request frame to AP4. In response to receiving the MAP request frame, AP4 transmits a MAP response frame to AP1.

Although FIG. 10 illustrates an example of frame exchanges for C-R-TWT, various changes may be made to FIG. 10. For example, various changes to the number of APs could be made, etc. according to particular needs.

In some embodiments, when a C-R-TWT initiating AP negotiates with a coordinated AP for a C-R-TWT schedule, based on the protection level expected from the coordinated AP, modes of the C-R-TWT schedule can be determined. For example, the modes may include any of the following modes:

### Mode-1: Only Ap Ending TXOP

In this mode, only the coordinated AP ends its TXOP before the C-R-TWT SP starts. The associated STAs in the coordinated AP's BSS do not need to end their TXOP.

### Mode-2: Both the Ap and Stas Ending TXOP

In this mode, both the coordinated AP and its associated STAs end their TXOP before the C-R-TWT SP starts.
   Mode-3: Qos-aware TXOP ending
In this mode, the coordinated AP or its associated STAs end their TXOPs before the C-R-TWT SP starts if certain QoS requirements are not violated. Otherwise, the TXOPs are not ended.
For example, a STA in the coordinated AP's BSS may end its TXOP only if the C-R-TWT SP does not overlap with any of its own high-priority QoS delivery windows.

In some embodiments, during an announcement phase (e.g., 906 of FIG. 9), the C-R-TWT initiating AP advertises the schedule in its BSS as a regular R-TWT. In embodiments such as these, the STAs associated with the initiating AP can be agnostic of whether the advertised R-TWT schedule is coordinated.

In some embodiments, during an announcement phase (e.g., 906 of FIG. 9), the C-R-TWT coordinated AP, in its schedule announcement, may make a distinction between an R-TWT schedule originating in its BSS and a schedule originating in the C-R-TWT initiating AP's BSS.

In some embodiments, during an announcement phase (e.g., 906 of FIG. 9), when a coordinated AP announces an R-TWT schedule in its BSS, the coordinated AP may make a distinction between an R-TWT schedule of its own and a schedule that is being coordinated. For example, in some embodiments, the announcement may include a marker in the schedule container distinguishing between an R-TWT schedule of the coordinated AP and a schedule that is being coordinated. This may allow some control on the prioritization of other factors over the C-R-TWT SP. For example, in some embodiments, the coordinated AP can dictate the behavior of its associated STAs on how to treat the two types of schedules. For instance, if the C-R-TWT coordinated AP has negotiated a mode-3 type of C-R-TWT schedule with the initiating AP, then the coordinated AP can dictate QoS-aware OBSS schedule prioritization rules for its own BSS.

In some embodiments, during an intra-BSS R-TWT negotiation phase (e.g., 908 of FIG. 9), a C-R-TWT initiating AP may advertise the schedule in its BSS as a regular R-TWT. In examples such as these, the STAs associated with the initiating AP can be agnostic of whether the advertised R-TWT schedule is coordinated. In some embodiments, the B-TWT ID used for intra-BSS schedule identification can be independent of the C-R-TWT schedule identifier used to identify the schedule for MAP coordination.

In some embodiments, during an intra-BSS R-TWT negotiation phase (e.g., 908 of FIG. 9), a C-R-TWT coordinated AP, in its intra-BSS schedule advertisement, may indicate that the schedule is open for membership (for instance, it has one or more associated STAs that have QoS delivery window that overlap with the C-R-TWT schedule). In embodiments such as these, the coordinated AP can indicate this condition (when it happens) to the C-R-TWT initiating AP (instead of tearing down the coordination). Otherwise, in some embodiments, the coordinated AP, in its intra-BSS schedule advertisement, can indicate that the advertised schedule is not open for membership (i.e., its schedule is full).

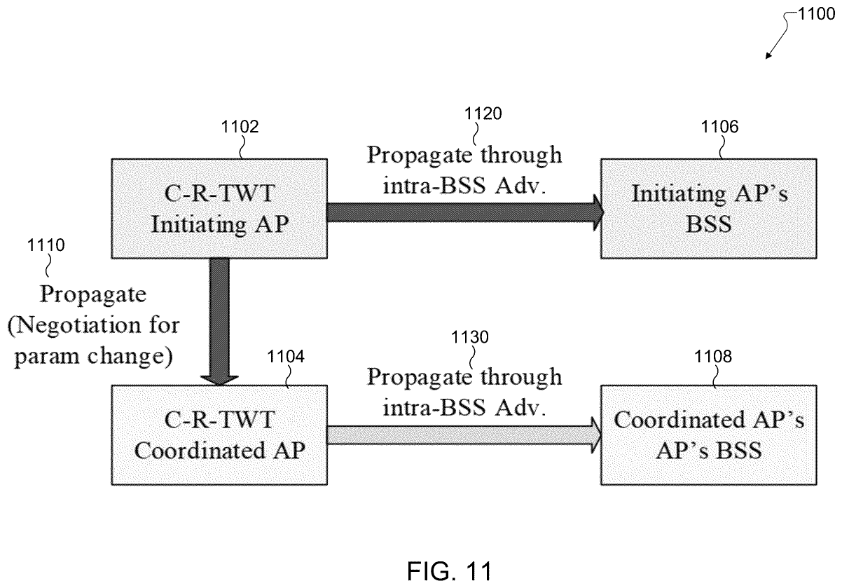

In some embodiments, during an intra-BSS R-TWT maintenance phase (e.g., 910 of FIG. 9), when an R-T-TWT initiating AP successfully negotiates an R-T-TWT schedule with a coordinated AP, any changes to the schedule parameter can be made by the initiating AP. In embodiments such as these, the R-T-TWT initiating AP may propagate the corresponding changes to the coordinated AP. For example, in some embodiments, if changes in a timing parameter (flexible) have been requested, the coordinated AP may enter into another round of negotiation with the initiating AP. In some embodiments, if the coordinated AP accepts the changes, the coordinated AP may propagate the changes to its own BSS through advertisement. An example of propagation of changes is shown in FIG. 11. In some embodiments, a schedule suspension/resumption request should be accepted by the coordinated AP.

FIG. 11 illustrates an example of propagation of changes in R-TWT 1100 according to embodiments of the present disclosure. The embodiment of propagation of changes in R-TWT of FIG. 11 is for illustration only. Different embodiments of propagation of changes in R-TWT could be used without departing from the scope of this disclosure.

In the example of FIG. 11, a C-R-TWT initiating AP 1102 changes a schedule parameter, and at step 1110, AP 1102 propagates the change to the schedule parameter to C-R-TWT coordination AP 1104, triggering a parameter change negotiation. At step 1120, C-R-TWT initiating AP 1102 propagates the changes to initiating AP 1102's BSS 1106 via an intra-BSS advertisement. Similarly, C-R-TWT coordination AP 1104 propagates the changes to C-R-TWT coordination AP 1104's BSS 1108 via an intra-BSS advertisement.

Although FIG. 11 illustrates one example of propagation of changes in R-TWT 1100, various changes may be made to FIG. 11. For example, various changes to order of steps could be made, etc. according to particular needs.

In some embodiments, during a C-R-TWT coordination termination/modification phase (e.g., 912 of FIG. 9), termination of a C-R-TWT coordination agreement can be made by either the initiating AP or the coordinated AP. For example, an unsolicited response for a schedule with a REJECT indication may result in the termination of the schedule.

In some embodiments, during a C-R-TWT coordination termination/modification phase (e.g., 912 of FIG. 9), modification in the coordination terms (e.g., changes in the modes) is performed through a negotiation. For example, the same request-response based approach used in the initial C-R-TWT setup can be used. In some embodiments, either the initiating AP or the coordinated AP can request changes in the coordination terms.

As noted above, various embodiments of the present disclosure provide frameworks for AP identification procedures for MAP coordination.

In some embodiments, for the scenario where a first AP intends to participate in MAP coordination with a second AP, in order to identify the second AP for different frame exchange purposes, the first AP can use an association identifier (AID). In some embodiments, the AID used by the first AP for this purpose may uniquely identify the second AP.

In some embodiments, if a first AP intends to participate in MAP coordination with a second AP and intends to send a relevant management frame or control frame or trigger frame or data frame to the second AP, the first AP can include in the frame sent to the second AP an identifier of the second AP so that the second AP would know that the frame is intended for the second AP. For example, the first AP can include an AID in the frame transmitted to the second AP, where the AID used can be specific to the second AP.

In some embodiments, when a first AP receives a first frame from a second AP where the frame includes an identification of the first AP (e.g., an AID value) indicating that the frame is intended for the first AP, the first AP may send a second frame, which can be a response frame, to the second AP, where the response frame for the second AP may include an identifier specific to the second AP so that the second AP can know that the response frame is intended for the second AP. In some embodiments, the identifier used in the first frame and the second frame can be AID values. In some embodiments, the identifier used in the first frame and the second frame can be a newly defined identifier used for identifying access points.

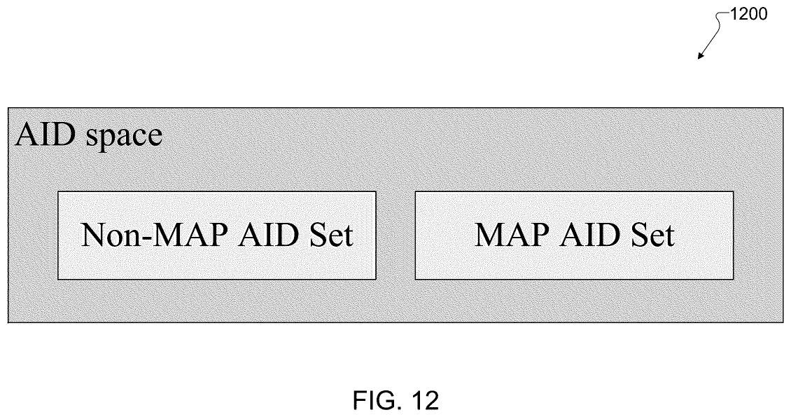

In some embodiments, if a first AP intends to participate in MAP coordination with a second AP, for identifying the second AP and other non-AP STAs associated with the first AP, the first AP can divide its AID space into multiple groups. For example, a first group of AIDs within the AID space can be designated for communication with different non-AP STAs associated with the first AP, and a second group of AIDs can be designated for communication with other APs for MAP coordination purposes. In embodiments, such as these the first group of AID values can be referred to as a non-MAP AID set, and the second group of AID values can be referred to as a MAP AID set, similar as shown in FIG. 12.

FIG. 12 illustrates an example AID grouping for MAP coordination 1200 according to embodiments of the present disclosure. The embodiment of AID grouping for MAP coordination of FIG. 12 is for illustration only. Different embodiments of AID grouping for MAP coordination could be used without departing from the scope of this disclosure.

In the example of FIG. 12, AID grouping for MAP coordination 1200 includes an AID space. The AID space includes a non-MAP AID set. The non-MAP AID set includes a group of AIDs within the AID space designated for communication with different non-AP STAs. The MAP AID Set includes a group of AIDs designated for communication with APs for MAP coordination purposes.

Although FIG. 12 illustrates one example AID grouping for MAP coordination 1200, various changes may be made to FIG. 12. For example, various changes to the AID sets could be made, etc. according to particular needs.

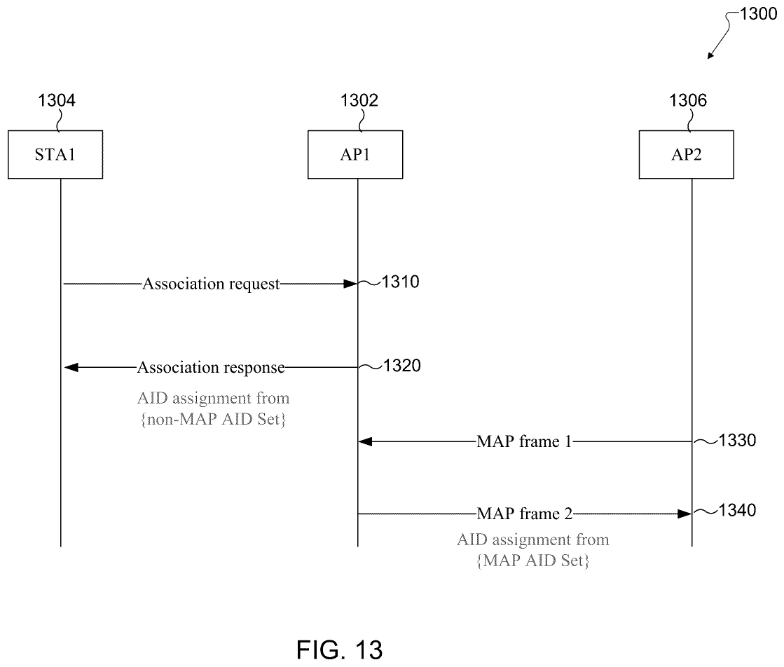

In some embodiments, if a first AP intends to participate in MAP coordination, when the first AP intends to assign an AID to a non-AP STA in its own BSS for the purpose of association with the first AP, the first AP may choose the AID value from the non-MAP AID set for that non-AP STA, similar as shown in FIG. 13.

In some embodiments, if a first AP intends to participate in MAP coordination, when the first AP intends to assign an AID to a second AP for the purpose of MAP coordination, the first AP may choose the AID value from the MAP AID set for the second AP, similar as shown in FIG. 13.

FIG. 13 illustrates an example use of different sets of AIDs for non-AP STAs and APs 1300 according to embodiments of the present disclosure. The embodiment of use of different sets of AIDs for non-AP STAs and APs of FIG. 13 is for illustration only. Different embodiments of a use of different sets of AIDs for non-AP STAs and APs could be used without departing from the scope of this disclosure.

In the example of FIG. 13, at step 1310, an AP (“AP1”) 1302 receives an association request from a STA (“STA1”) 1304. At step 1320, AP 1302 transmits an association response to STA 1304. The association response includes an AID assignment from a non-MAP AID set of AP 1302.

At step 1330 AP 1302 receives a first MAP frame from another AP (“AP2”) 1306. At step 1340, AP 1302 transmits a second MAP frame to AP 1306. The MAP frame includes an AID assignment from a MAP AID set of AP 1302.

Although FIG. 13 illustrates one example use of different sets of AIDs for non-AP STAs and APs 1300, various changes may be made to FIG. 13. For example, various changes to the order of the steps could be made, additional STAs or APs could be included, etc. according to particular needs.

In some embodiments, for the scenario where a first AP intends to participate in MAP coordination with a second AP, in order to identify the second AP for different frame exchange purposes, the first AP can use a tuple <AID, TA>, where TA is the transmitter address identifying the transmitter of the frame. In some embodiments, the <AID, TA> tuple may uniquely identify the AP for which the frame is intended.

In some embodiments, for the scenario where an <AID, TA> tuple is used by a first AP to identify a second AP, the TA value in the tuple can be the TA value of the first AP, and the AID value can be the AID of the second AP. In embodiments such as these, if this tuple is used, the same AID value can be assigned to more than one AP in the network. For example, a first AP can assign AID 1 to a second AP, and a third AP can also assign AID 1 to a fourth AP. In such cases, in the tuple, the TA value can identify the assigning agent/AP.

In some embodiments, for the scenario where a first AP intends to participate in MAP coordination with a second AP, in order to identify the second AP for different frame exchange purposes, the first AP can use a tuple <AID, RA>, where RA is the receiver address identifying the receiver of the frame. In some embodiments, the <AID, RA> tuple may uniquely identify the AP for which the frame is intended.

In some embodiments, for the scenario where an <AID, RA> tuple is used by a first AP to identify a second AP, the RA value in the tuple can be the RA value of the second AP, and the AID value can be the AID of the second AP. In embodiments such as these, if this tuple is used, the same AID value can be assigned to more than one AP in the network. For example, a first AP can assign AID 1 to a second AP, and a third AP can also assign AID 1 to a fourth AP. In such cases, in the tuple, the RA value can identify the intended agent/AP.

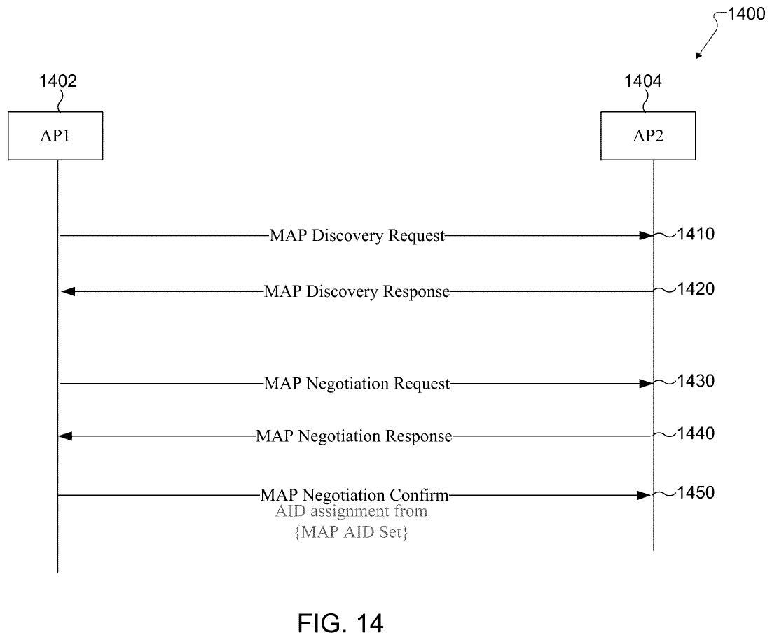

In some embodiments, for the scenario where a first AP intends to participate in MAP coordination with a second AP, the first AP can assign the identification of the second AP (e.g., an AID value or <AID, TA/RA> tuple) during the discovery or negotiation phases of the MAP coordination, similar as shown in FIG. 14. This process of AID assignment can be useful for a non-enterprise network or residential network.

FIG. 14 illustrates an example AID assignment during a MAP negotiation phase 1400 according to embodiments of the present disclosure. The embodiment of AID assignment during a MAP negotiation phase of FIG. 14 is for illustration only. Different embodiments of AID assignment during a MAP negotiation phase could be used without departing from the scope of this disclosure.

In the example of FIG. 14, at step 1410, a first AP (“AP1”) 1402 transmits a map discovery request frame, and receives a MAP discovery response frame from a second AP (“AP2”) 1404 at step 1420.

At step 1430, AP 1402 transmits a map negotiation request frame to AP 1404, and receives a MAP negotiation response frame from AP 1404 at step 1420.

At step 1450, AP 1402 transmits a map negotiation confirm frame to AP 1404. The MAP negotiation confirm frame includes an AID assignment for AP 1404 from a MAP AID set of AP 1402.

Although FIG. 14 illustrates one example AID assignment during a MAP negotiation phase 1400, various changes may be made to FIG. 14. For example, various changes to the order of steps could be made, etc. according to particular needs.

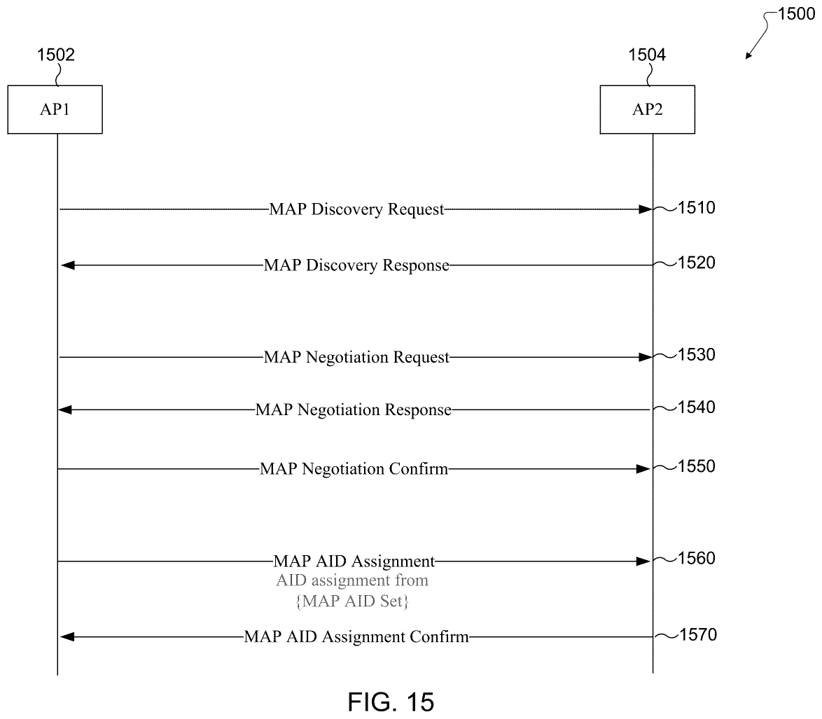

In some embodiments, for the scenario where a first AP intends to participate in MAP coordination with a second AP, the first AP can assign the identification of the second AP (e.g., AID value or <AID, TA/RA> tuple) during a separate frame exchange that can take place after the initial discovery and negotiation between the first AP and the second AP has been confirmed, similar as shown in FIG. 15.

FIG. 15 illustrates an example AID assignment in separate management frame exchanges 1500 according to embodiments of the present disclosure. The embodiment of AID assignment in separate management frame exchanges of FIG. 15 is for illustration only. Different embodiments of AID assignment in separate management frame exchanges could be used without departing from the scope of this disclosure.

In the example of FIG. 15, at step 1510, a first AP (“AP1”) 1502 transmits a map discovery request frame, and receives a MAP discovery response frame from a second AP (“AP2”) 1504 at step 1520.

At step 1530, AP 1502 transmits a map negotiation request frame to AP 1504, and receives a MAP negotiation response frame from AP 1504 at step 1520. At step 1550, AP 1502 transmits a map negotiation confirm frame to AP 1504.

At step 1560, AP 1502 transmits a MAP AID assignment frame to AP 1504. The MAP AID assignment frame includes an AID assignment for AP 1504 from a MAP AID set of AP 1502. At step 1570, AP 1502 receives a MAP AID assignment confirm frame from AP 1504.

Although FIG. 15 illustrates one example AID assignment in separate management frame exchanges 1500, various changes may be made to FIG. 15. For example, various changes to the order of steps could be made, etc. according to particular needs.

In some embodiments, for MAP coordination, if the participating APs are controlled by a central controlling unit, then the central controlling unit can assign the AID values or other identifier values for those different participating APs. In embodiments such as these, the central controller can strive to assign unique AID or identifiers for different APs in order to minimize AID conflict among different participating APs.

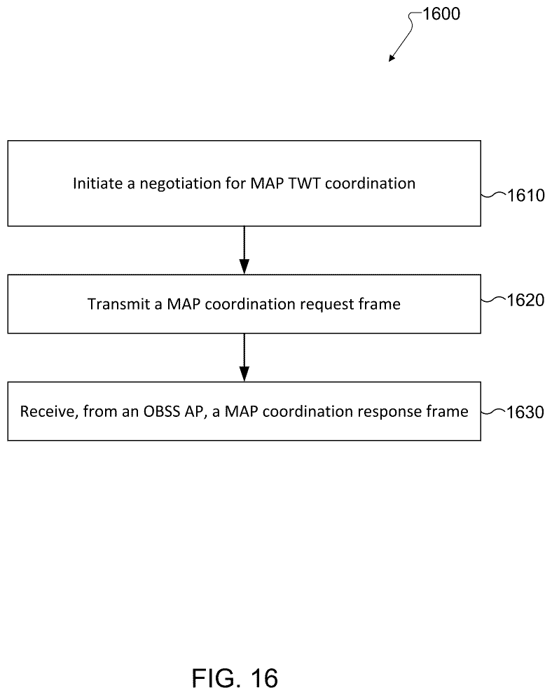

FIG. 16 illustrates an example method for enhanced coordinated restricted TWT operation 1600 according to embodiments of the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of a method for enhanced coordinated restricted TWT operation could be used without departing from the scope of this disclosure.

In the example of FIG. 16, method 1600 begins at step 1610. At step 1610, a first AP (such as AP1 of FIG. 8) initiates a negotiation for MAP TWT coordination.

At step 1620, the first AP transmits a MAP coordination request frame. In some embodiments, the MAP coordination request frame may include TWT coordination related information. In some embodiments, the MAP coordination request frame may include information for different types of MAP coordination. In some embodiments the MAP coordination request frame may include a presence bitmap, where each bit of the presence bitmap may indicate whether information corresponding to a particular coordination method is present in the MAP coordination request frame.

In some embodiments, the MAP coordination request frame may include at least one TWT coordination element including TWT schedule information that the first AP wants to schedule with the second AP. In embodiments such as these, the MAP coordination request frame may include a subfield indicating that the at least one TWT coordination element is present in the MAP coordination request frame.

At step 1630, the first AP receives, from a second AP (such as AP2 of FIG. 8), a MAP coordination response frame. The second AP is an OBSS AP for the first AP. In some embodiments, the MAP coordination response frame may indicate preferred parameters of the second AP for the MAP TWT coordination. In some embodiments, the MAP coordination response frame may include information for different types of MAP coordination. In some embodiments, the MAP coordination response frame may include a presence bitmap, each bit of the presence bitmap indicating whether information corresponding to a particular coordination method is present in the MAP coordination response frame. In some embodiments, the MAP coordination response frame may include at least one TWT coordination element including TWT schedule information that the second AP wants to schedule with the first AP.

Although FIG. 16 illustrates one example method for enhanced coordinated restricted TWT operation 1600, various changes may be made to FIG. 16. For example, while shown as a series of steps, various steps in FIG. 16 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompasses such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A first access point (AP) comprising:
a processor configured to cause the first AP to perform a negotiation for Multi-AP (MAP) target wake time (TWT) coordination; and
a transceiver operably coupled to the processor, the transceiver configured to, during the negotiation for MAP TWT coordination:
transmit a MAP coordination request frame; and
receive, from a second AP, a MAP coordination response frame,
wherein the second AP is an overlapping basic service set (OBSS) AP for the first AP.

2. The first AP of claim 1, wherein the MAP coordination request frame includes TWT coordination related information.

3. The first AP of claim 1, wherein the MAP coordination request frame includes information for different types of MAP coordination.

4. The first AP of claim 1, wherein the MAP coordination request frame includes a presence bitmap, each bit of the presence bitmap indicating whether information corresponding to a particular coordination method is present in the MAP coordination request frame.

5. The first AP of claim 1, wherein the MAP coordination request frame includes at least one TWT coordination element including TWT schedule information that the first AP wants to schedule with the second AP.

6. The first AP of claim 5, wherein the MAP coordination request frame includes a subfield indicating that the at least one TWT coordination element is present in the MAP coordination request frame.

7. The first AP of claim 1, wherein the MAP coordination response frame indicates preferred parameters of the second AP for the MAP TWT coordination.

8. The first AP of claim 1, wherein the MAP coordination response frame includes information for different types of MAP coordination.

9. The first AP of claim 1, wherein the MAP coordination response frame includes a presence bitmap, each bit of the presence bitmap indicating whether information corresponding to a particular coordination method is present in the MAP coordination response frame.

10. The first AP of claim 1, wherein the MAP coordination response frame includes at least one TWT coordination element including TWT schedule information that the second AP wants to schedule with the first AP.

11. A second access point (AP) comprising:
a processor; and
a transceiver operably coupled to the processor, the transceiver configured to, during a negotiation for Multi-AP (MAP) target wake time (TWT) coordination:
receive, from a first AP, a MAP coordination request frame; and
transmit, to the first AP, a MAP coordination response frame,
wherein the first AP is an overlapping basic service set (OBSS) AP for the second AP.

12. The second AP of claim 11, wherein the MAP coordination request frame includes TWT coordination related information.

13. The second AP of claim 11, wherein the MAP coordination request frame includes information for different types of MAP coordination.

14. The second AP of claim 11, wherein the MAP coordination request frame includes a presence bitmap, each bit of the presence bitmap indicating whether information corresponding to a particular coordination method is present in the MAP coordination request frame.

15. The second AP of claim 11, wherein the MAP coordination request frame includes at least one TWT coordination element including TWT schedule information that the first AP wants to schedule with the second AP.

16. The second AP of claim 15, wherein the MAP coordination request frame includes a subfield indicating that the at least one TWT coordination element is present in the MAP coordination request frame.

17. The second AP of claim 11, wherein the MAP coordination response frame indicates preferred parameters of the second AP for the MAP TWT coordination.

18. The second AP of claim 11, wherein the MAP coordination response frame includes information for different types of MAP coordination.

19. The second AP of claim 11, wherein the MAP coordination response frame includes a presence bitmap, each bit of the presence bitmap indicating whether information corresponding to a particular coordination method is present in the MAP coordination response frame.

20. The second AP of claim 11, wherein the MAP coordination response frame includes at least one TWT coordination element including TWT schedule information that the second AP wants to schedule with the first AP.
